(19) United States
(12) Patent Application Publication
(10) Pub. No.: US 2007/0062469 A1
(43) Pub. Date: Mar. 22, 2007

(54) Rotary radial internal combustion piston engine

(76) Inventor: Leonid Yakhnis, Haifa (IL)

Correspondence Address: Leonid Yakhnis, St. Yad Lebanim, 182/17, Haifa, 32698, IL

(21) Appl. No.: 11/227,553

(22) Filed: Sep. 16, 2005

(51) Int. Cl. F02B 57/08; F02B 57/06

(52) U.S. Cl. 123/44 C

(57) ABSTRACT

The engine comprises a housing, a rotor having a driven shaft fastened thereon, which is mounted on the bearings spaced coaxially apart in the opposite sides of the housing and rotates about its axis of rotation and has a pair radially opposite cylinders spaced in the body of the rotor eccentrically and equidistantly relative to its axis of rotation. One radially outer end of each cylinder is closed by the wall and the other end is closed by piston which slides within the cylinder. Gas intake and gas exhaust may take place through the ducts in the body of the rotor extending from the cylinders to the inner pipe port of the driven shaft. There is a rotary ring mounted on the bearings spaced coaxially apart in the opposite sides of the housing. It rotates about its axis of rotation spaced apart from the rotor axis by an eccentricity and being impelled to rotate in the same direction and with the same velocity relative to the rotor by pins of the rotor. The pistons are connected to the rotary ring through the connecting rods.

### CROSS-REFERENCE TO RELATED APPLICATTIONS

Patent Documents:

| | | | |
|---|---|---|---|
| US 2003/0154936 A1 | 08-2003 | Santiyanont, Chanchai | 123/44.00 D |
| U.S. Pat. No. 6,536,383 | 03-2003 | Santiyanont, Chanchai | 123/44 D |
| B2 | | | |
| U.S. Pat. No. 6,062,175 | 05-2000 | Huang, Shih-Pin | 123/44 D |
| U.S. Pat. No. 5,967,102 | 10-1999 | Huang, Shih-Pin | 123/44 D |
| U.S. Pat. No. 4,166,438 | 09-1979 | Gottschalk, Eldon W. | 123/44 D |
| U.S. Pat. No. 2,990,820 | 07-1961 | Genzo Saijo | 123/44 D |
| U.S. Pat. No. 1,341,328 | 05-1920 | Lamplough | 123/44 D |
| EP 391866 A1 | 10-1990 | Calamandrei, Luigi | F01B 005/00 |

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISK

Not Applicable

### REFERENCE TO A “MICROFICHE APPENDIX”

Not Applicable

### BACKGROUND OF THE INVENTION

1. Field of the Invention

The present invention relates to the machinebuilding and can be applied in the form of an internal combustion engine, a gas engine, a hydraulic motor, a gas compressor and a hydraulic pump

2. Description of the Related Art

The Rotary Compressor or Pump is the object of invention US 2003/0154936 A1. Said compressor has a fixed cylindrical casing, supporting a rotor having an externally driven input shaft extending rotatably and coaxially in the casing. The rotor includes piston chambers and reciprocable pistons in the piston chamber. A piston rod of each piston is connected to a crankshaft connected to the rotor for rotation therewith. As the input shaft and crankshafts concurrently rotate the pistons reciprocate in their piston chambers due to the rotation of crankshafts. The casing has fluid suction and discharge ports communicating with the piston chambers during rotation of the rotor to admit fluid through the suction port and discharge compressed fluid from the discharge port. A drive train synchronizes rotation of the crankshafts and the input shaft, a gear tooth ratio of an annular gear to pinion gears on the crankshafts is preferably twice the number of pistons in each rotor block.

The Internal Combustion Rotary Engine is the object of invention U.S. Pat. No. 6,536,383 B2.

An internal combustion rotary engine of the type comprising a rotor, an output shaft as the rotor axis, crankshafts mounting on output shaft, pistons reciprocable in piston chambers within the rotor, piston rods connecting the pistons to the crank of crankshaft. This rotary engine is characterized by the ignition force perpendicular to the output shaft radius, by radially spaced the crankshaft axis from output shaft axis, by connection between the output shaft and the crankshafts to concurrently synchronize them.

Rotating cylinder internal-combustion engine is the object of invention U.S. Pat. No. 6,062,175.

An internal combustion engine comprises multiple cylinder blocks in series rotatablely mounted in a single casing. The multiple cylinder blocks rotatably provided in series in said casing and each corresponding to one of the gears respectively, each cylinder block having multiple cylinders, defined along a circumferential portion of the cylinder block to respectively receive a piston therein, each of the cylinders being accessible to one of the spark plugs, the exhaust ports or the intake ports upon rotation of the cylinder block, wherein the piston is pivotally attached to a connecting rod which is pivotally connected to a pinion which in turn meshes with one of the corresponding gears. The piston and the connecting rod are similar to the conventional elements. It is noted that the connecting rod is eccentrically mounted on the pinion to convert the reciprocating linear motion to rotary motion.

Combustion engine construction is the object of invention U.S. Pat. No. 5,967,102.

A rotary combustion engine construction includes an engine block defining a cylindrical inner space in which a toothed ring portion is integrally attached with the engine block, and a cylindrical block rotatably and snugly fitted in the cylindrical inner space of the engine block. A number of spark plugs are installed on the engine block at angular intervals. The cylindrical block defines a number of cylinder bores therein along a circumferential portion thereof to each receive a piston which is pivotally attached with a connecting rod which is pivotally connected with a crank which is coaxially and fixedly connected with a pinion meshing with the toothed ring portion formed with the engine block, so that the piston may conduct reciprocal movement along the respective cylinder bore and thus the pinion may be driven into rotation that allows the cylindrical block together with an output axle to rotate with respect to the engine block to supply a rotation mechanical power output.

Machine with reciprocating pistons and rotating piston carrier is the object of invention U.S. Pat. No. 4,166,438.

A reciprocating piston machine useful as a pump, a hydraulic motor or an internal combustion engine has a plurality of cylinders in a carrier surrounding a central shaft. The carrier is in turn surrounded by a ported manifold. Said carrier being fixed to said work shaft, a crankshaft rotatable by each piston, a crank gear on each crankshaft, a ring gear fixed to said housing and meshing with each crank gear. The carrier and manifold are adapted for relative rotation one to another such that the cylinders periodically open to the ported manifold. Pistons within the cylinders each describe a path in the carrier tangent to a circle in the plane of rotation of the carrier. A gear fixed to the manifold housing about the central shaft induces relative motion between the manifold and the carrier by linkage including gears and shafts and connecting rods of the pistons.

Rotating mechanism of main shaft of oil engine is the object of invention U.S. Pat. No. 2,990,820.

Said Rotating mechanism has the casing in which is mounted a cylinder housing in which the main shaft is fixed and also equidistant from the main shaft in the cylinder housing are mounted four combustion chambers or cylinders at 90 DEG. intervals. Between the casing and the cylinder housing are mounted four partition pieces which have respectively small holes for gas inlet and outlet. These partition pieces lie flush with the inner surface of the casing and slide freely thereon. In the combustion chambers above mentioned, which are part of the partition pieces, are mounted pistons. Two of these pistons which are disposed at mutually opposed position form one pair and pistons another pair. Each piston is connected respectively to crank pins of crankshafts and respectively by connecting rods. On each crankshaft which are disposed at 90 DEG intervals, are installed pinions respectively and each pinion meshes with the gear which is rigidly fixed to and concentric with bearing housing.

Hydraulic engine is the object of invention U.S. Pat. No. 1,341,328.

Said engine has a stationary valve shaft, a ported casing rotatably mounted on said shaft, a plurality of pairs of open ended cylinders formed in said casing and communicating at their inner ends with a chamber common to both cylinders of each pair, a piston in each of said cylinders, said cylinders each having one end open to receive motive fluid from said valve shaft through said ports, crankshafts journaled in said casing and operatively connected to said pistons, and means operatively connected to said crankshafts for rotating the casing when motive fluid is supplied thereto substantially as described.

Fluid motor with rotary movement is the object of invention EP 391866 A1.

The pressure-driven motor has a main rotor with pistons and connecting rods working in one or more rings of cylinder. The protruding free ends of the rods pivot on an auxiliary rotor turning on an axis eccentric to that of the main one. The rotors are coupled together by means of four cranks spaced and orientated of the same way, which turn around two corresponding axes. Air or fluid is delivered to the cylinders by a distributors. The main rotor is fixed to a driving shaft . The rotors are coupled by components giving instantaneous angular velocity and driving torque of the auxiliary one equal to those of the main one.

Each of above engines [0001]-[0007] may be used in the form of the four or two-stroke internal combustion engine which operates according to the Otto cycle. Each of said engines comprises a “cylinder-piston” unit which is supplied to provide fuel burning to obtain the heat and to transform it into piston mechanical linear movement (reciprocation) within cylinder, and a “crankshaft” unit which is supplied to convert reciprocation of the piston into rotation of the driven shaft. Those signs are essential signs of a conventional internal combustion crankshaft engine, and so all said engines are the modifications of a conventional internal combustion crankshaft engine and they have all essential disadvantages of the conventional internal combustion crankshaft engines.

Above Fluid Motor [0008] may be used in the form of an rotary engine which operates according to the Brayton cycle but it has been designed such that it can not be applied in the form of the four or two-stroke internal combustion engine which operates according Otto cycle. In the form of internal combustion engine the design of this one has essential disadvantages:
it is difficult to provide the required precision of the cranks (components of the means of link) displacement by the technology of the manufacturing of the engine,
the design has too weak structure,
it is impossible for said cranks which turn around two corresponding axes in the slide bearings to be used under operating conditions of conventional rotary internal combustion engines (n=5,000-8,000 r.p.m., M=70-100 kGm).There are no actual examples of such technical solutions in the world.

### BRIEF SUMMARY OF THE INVENTION

The aim of the present project is to provide a new design of an internal combustion rotor engine which has all advantages of the rotor engine but more efficient and has no problems of both the conventional internal combustion crankshaft engine and the internal combustion rotor engine such as Wankel one. Rotary internal combustion engines are quite old in the art. There are variety of directions of improvements to overcome the disadvantages of a conventional crankshaft engine but it is the fact that its essential disadvantages impossible to overcome by modification of the conventional one.

The design of conventional internal combustion crankshaft engine comprises two basic components. The first component is a “cylinder-piston” unit and it is supplied to provide fuel burning, to obtain the heat and to transform it into mechanical piston movement (reciprocation) within cylinder. This component is highly effective. The second component of conventional engine is a “crankshaft” unit and it is supplied to convert reciprocation of the piston into rotation of the driven shaft. The efficiency of this component is less than 45% and that is one of the essential causes of low efficiency of conventional engine at all. In all the previous attempts to create a rotor engine without crankshaft to increase the efficiency, both basic units of conventional engine had been changed and those attempts were not successful.

So to create efficient and practical internal combustion engine its design must be:
operates according to the Otto cycle,
rotary,
same simple and more technological in the manufacturing compared to the conventional crankshaft engine,
far the most technological in the manufacturing and of much greater reliability and work ability compared to Wankel one.
   The present invention design operates according to the Otto cycle, comprises a “cylinder-piston” unit being exactly the same as the conventional engine one and used exactly the same technology of obtaining the heat and transforming it into mechanical movement of the piston relative to the cylinder (or the cylinder relative to the piston). At the same time both the piston and the cylinder are impelled by gas under pressure and rotate about two stationary and eccentrical axes correspondently and so affording power on the driven shaft without using “crankshaft” unit. The design of this novel engine is practical, simple and technological in the manufacturing.

### BRIEF DESCRIPTION OF THE SEVERAL VIEWS OF THE DRAWING

The invention would be described now with reference to the:

FIGS. 1, 2 illustrate the construction of the engine and a manner in which it operates.

FIG. 3 is isometric view of engine.

FIG. 4 corresponds to FIGS. 3 in greater detail.

### DETAILED DESCRIPTION OF THE INVENTION

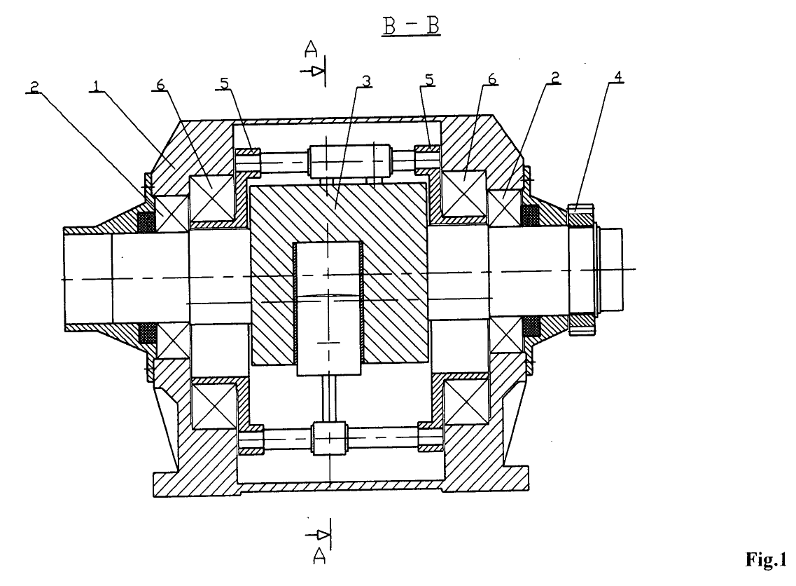

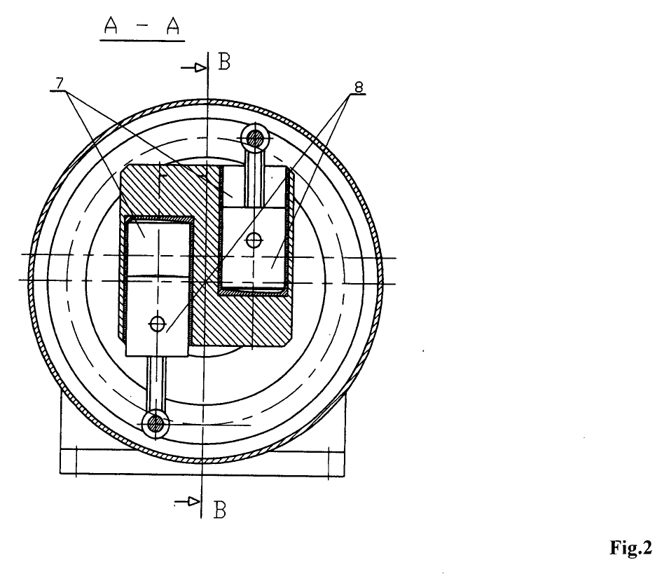

Turning first to FIGS. 1-2:

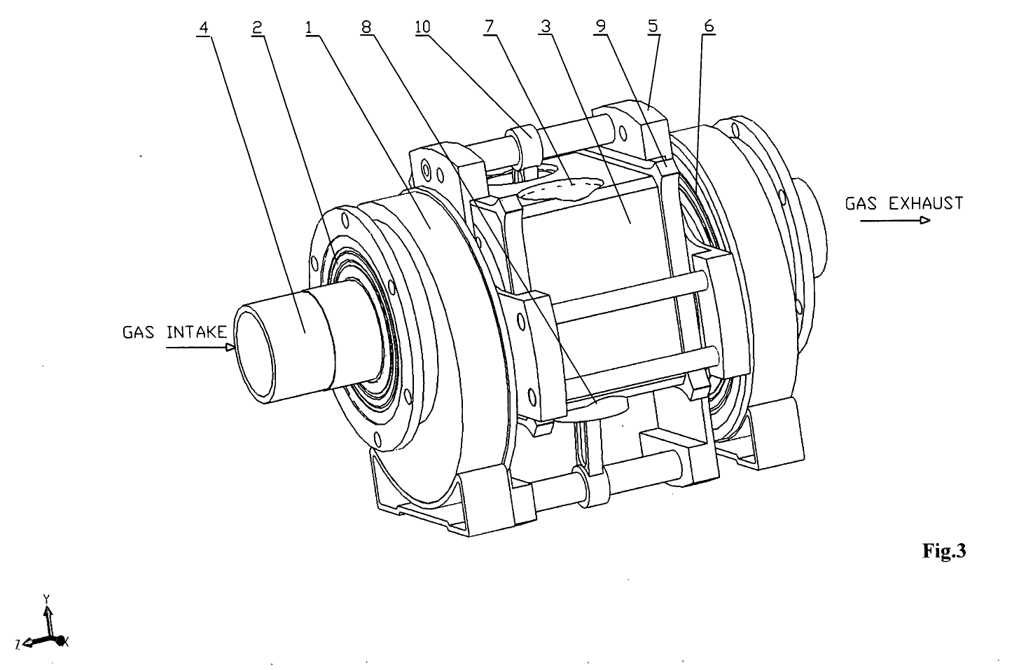

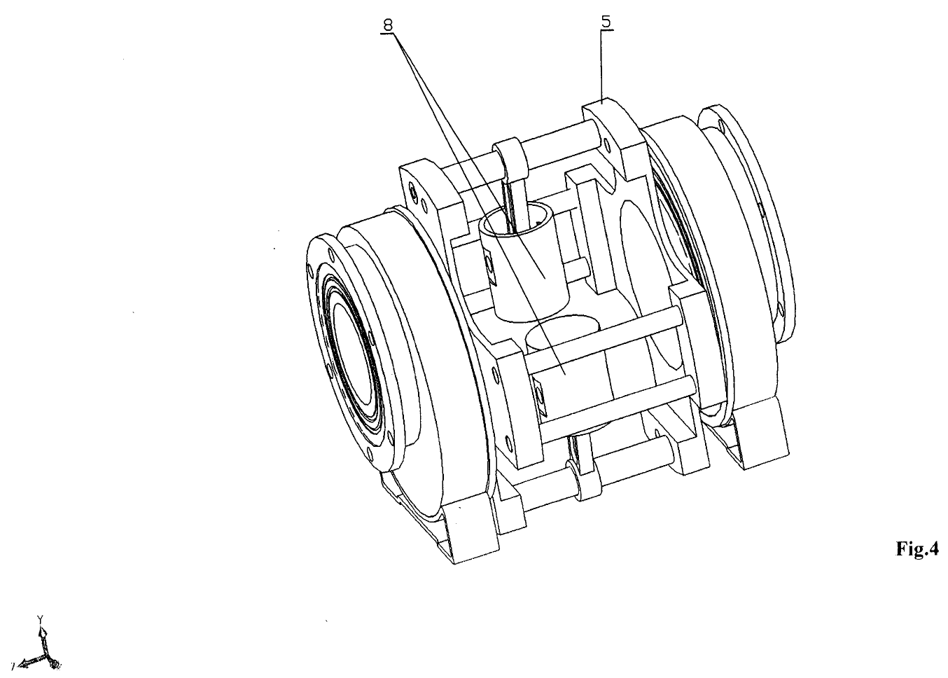

New engine comprises a housing (1), a rotor (3) having a driven shaft 4) fastened thereon, which is mounted on the bearings (2) spaced coaxially apart in the opposite sides of the housing and rotates about its axis of rotation and has a pair radially opposite cylinders (7) spaced in the body of the rotor eccentrically and equidistantly relative to its axis of rotation. One radially outer end of each cylinder is closed by the wall and the other end is closed by piston (8) which slides within the cylinder. Gas intake and gas exhaust may take place through the ducts in the body of the rotor extending from the cylinders to the inner pipe port of the driven shaft. There is a rotary ring (5) mounted on the bearings (6) spaced coaxially apart in the opposite sides of the housing. It rotates about its axis of rotation spaced apart from the rotor axis by an eccentricity and being impelled to rotate in the same direction and with the same velocity relative to the rotor by pins (9), (FIG. 3) of the rotor. The pistons are connected to the rotary ring through the connecting rods (10), (FIG. 3).

In general operation of the engine, while the housing remains stationary, the rotor with cylinders, pistons, connecting rods and the rotary ring rotate in the same direction and with the same velocity about the rotor and the rotory ring axes of rotation correspondently. The above axes are not coaxial and therefore both the piston and the cylinder slide with respect one to another. Both the cylinders and the pistons are impelled by gas under pressure. One way the pressure acts through the pistons and connecting rods to the rotary ring and through the bearings of the rotary ring to the housing. Another way it acts through the cylinders (the bottom walls of the cylinders) to the rotor and to the driven shaft being eccentrical relative to the axis of rotation of rotory ring and so affords power.

The technical features of the Rotary Radial Internal Combustion Engine [A], (Application/Control Number: 11/227,553)

1. a housing (1),

2. a rotor (3),

3. fastened to the driven shaft (4),

4. mounted in said housing for rotation about the axis of said rotor,

5. having ducts for gas intake and gas exhaust,

6. the cylinders (7),

7. spaced in said rotor radially from an axis of rotation of said rotor,

8. the connecting rods (10),

9. the pistons (8),

10. spaced in each of said cylinders for displacement along the respective cylinder axes,

11. being connected to said rotary ring through said connecting rods,

12. a rotary ring (5),

13. mounted in said housing for rotation about the axis of said rotary ring being parallel and spaced apart from the axis of said rotor,

14. being impelled to rotate in the same direction and with the same velocity relative to the rotor,

15. the pins (9) of said rotor to synchronize said rotor with said rotary ring and achieve equal angular speed and engine torque,

The technical features of the Fluid Motor with Rotary Movement [B], (Pub. Number: EP 0 391,866 A1)

1. a housing (Not Numbered)

2. a main rotor (1)

3. mounted for rotation around its axis (Z)

4. the cylinders (11)

5. spaced in said main rotor

6. the pistons (3)

7. spaced in said cylinders

8. an auxiliary rotor (6)

9. mounted for rotation around its axis (z) being eccentrical to that of said main rotor

10. the connecting rods (4)

11. connected to said pistons

12. the protruding free ends of said connecting rods pivoted on an said auxiliary rotor

13. the means of link (7) (cranks) to synchronize said auxiliary rotor with said main rotor and achieve equal angular speed and engine torque

14. the means for introduction and removal of fluid in the cylinders (several components) (80,81,82).

The technical features of the Rotary Compressor or Pump [C] (Pub. Number US 2003/0154936 A1)

1. a fixed cylindrical casing (C)

2. a rotor (R)

3. mounted in said casing for rotation

4. an input shaft (4)

5. externally driven

6. extending rotatably in said casing

7. extending coaxially in said casing

8. plurality of piston chambers (13)

9. spaced in the said rotor radially from an axis of rotation of said input shaft

10. plurality of pistons (19)

11. spaced in the said piston chambers

12. being reciprocable in said piston chambers along its axes

13. the crankshafts (21)

14. connected to said rotor for rotation therewith

15. the piston rods (20)

16. connected to said pistons

17. connected to said crankshaft

18. fluid suction ports (6)

19. spaced in said casing

20. fluid discharge ports (5)

21. spaced in said casing

22. the valve members (15)

23. spaced on each said piston chamber

24. having a cylindrically shaped end

25. a drive train (several components) (2),(24-26),(10)

Comparison of the technical features of the Rotary Radial Internal Combustion Engine [A], Application/Control Number: 11/227,553 with the technical features of Fluid Motor with Rotary Movement [B], Pub. Number: EP 0 391,866 A1

1. Technical features 1-7, 10-12 [B] correspond to technical features 1-14 [A] and they are the same both for design and for functional aspects.

2. Technical features 8-9,13 [B] correspond to technical features 15 [A] and they are the same for the functional but essentially different for the design aspects.

3. Engine [A] does not have technical feature similar to technical feature 14 which are used in engine [B].

Investigation:

1. Technical features 8-9,13 [B] (the means of link) define several components of the unit meant to synchronize the auxiliary rotor with the main rotor and achieve equal angular speed and engine torque. The engine [B] has four cranks in said units.

Technical features 15 [A] ( pins of the rotor) fulfill the same function. It is evident that design of engine [A] more simpler and easier to manufacture.

2. It seems impossible for said cranks (components of the means of link [B]) which turn around two corresponding axes in slide bearings to be used under operating conditions of conventional rotary internal combustion engines (n=5,000-8,000 r.p.m., M=70-100 kGm).There are no actual examples of such technical solutions in the world.

3. Said four cranks [B] are spaced interdependently and orientated in the same way both in the auxiliary and main rotors. It is difficult to provide the required precision of the cranks displacement by the technology of the manufacturing of the engine.

4. Technical features 14 [B] define the means for introduction and removal of fluid in the cylinders.

Engine [A] does not have technical features similar to technical features 14 which are used in engine [B].

Conclusion:

The designs of the engines [A] and [B] are essentially different both in terms of design and functionality. The engine [B] has been designed such that it can not be applied in the form of the four or two-stroke rotary internal combustion engine which operates according to the Otto cycle, but that is exactly the main objective of my invention.

Comparison of the technical features of the Rotary Radial Internal Combustion Engine [A], Application/Control Number: 11/227,553 with the technical features of the Rotary Compressor or Pump [C] (Pub. Number US 2003/0154936 A1).

1. Technical features 1-3, 8-11, 15-16 [C] correspond to technical features 1-4, 6-9 [A] and they are the same both for design and for functional aspects.

2. Engine [A] does not have technical features similar to technical features 4-7, 12-14, 17-25 which are used in engine [C]

3. Engine [C] does not have technical features similar to technical features 5, 10-15 which are used in engine [A]

Investigation:

1. Technical features 4-7, 12-14, 17, 25 [C] define the crankshaft units. As the input shaft and crankshafts rotate concurrently the pistons reciprocate in their piston chambers. Each piston moves linearly within the corresponding piston chamber with the reversal of the piston travel, both at top and bottom of its reciprocating strokes (at both extremes of travel).

Engine [A] does not have technical features similar to technical features 4-7, 12-14, 17,25 which are used in engine [C]. The pistons of the engine [A] rotate in the same direction and with the same velocity as the rotor and rotary ring, and have only rotary and no linear speed.

2. Technical features 18-24 [C] define the mechanism of distribution of the fluid from the housing to the cylinders.

Engine [A] does not have a fluid distribution mechanism. In the engine [A] gas intake and gas exhaust take place through the ducts in the body of the rotor.

3. Engine [C] does not have technical features similar to technical features 10-15 which are used in engine [A], but these exact technical signs define engine [A] as a Rotary Engine.

Conclusion:

The designs of the engines [A] and [C] are essentially different both in terms of design and functionality. The engine [A] is a Rotary Internal Combustion Engine but the engine [C] is the modification of the Crankshaft Engine. Beside that, the engine [C] has been designed such that it can not be applied in the form of the four or two-stroke internal combustion engine. Patent US 2003/0154936 A1 claimed it only as a fluid pressurizing device.

1. A Rotary Radial Internal Combustion Piston Engine comprises:
a housing,
a rotor having a driven shaft fastened thereon, mounted in said housing for rotation about an axis of said rotor, and having ducts for gas intake and gas exhaust, cylinders spaced in said rotor radially from the axis of rotation of said rotor, a piston spaced in each of said cylinders for displacement along the respective cylinder axis,
a rotary ring which is mounted in said housing for rotation around axis of said rotary ring being parallel and spaced apart from the axis of said rotor and being connected to said pistons for rotation therewith and being impelled to rotate in the same direction and with the same velocity relative to the rotor by pins of the rotor.
